(19) United States
(12) Patent Application Publication
(10) Pub. No.: US 2006/0221089 A1
(43) Pub. Date: Oct. 5, 2006

(54) Memory controller, image processing controller, and electronic instrument

(75) Inventors: Tetsuo Kawamoto, Chino (JP); Toshiyuki Yamamoto, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/389,459

(22) Filed: Mar. 24, 2006

(30) Foreign Application Priority Data
Mar. 30, 2005 (JP) 2005-097984

(51) Int. Cl. G09G 5/39

(52) U.S. Cl. 345/531

(57) ABSTRACT

A memory controller including: a rectangular area designation register which is used for designating a rectangular area inside a display area; an address generation circuit which generates an address of the memory corresponding to a position of each pixel inside the rectangular area; a color designation register in which designated pixel data is designated; and a bit block transfer control register. When the bit block transfer is enabled, the memory controller writes the designated pixel data in the memory based on the address generated by the address generation circuit corresponding to a bit block transfer rectangular area. When the bit block transfer is disabled, the memory controller writes input pixel data in the memory based on the address generated by the address generation circuit corresponding to an input pixel data transfer rectangular area.

Japanese Patent Application No. 2005-97984, filed on Mar. 30, 2005, is hereby incorporated by reference in its entirety.

### BACKGROUND OF THE INVENTION

The present invention relates to a memory controller, an image processing controller, and an electronic instrument.

An image processing controller has been known which reduces the processing load imposed on a host which controls a display system by processing an image such as an image displayed on a screen of a display device such as a liquid crystal display (hereinafter abbreviated as “LCD”) panel or a CRT instead of the host. The image processing controller processes an image using a display memory (memory in a broad sense).

In the display memory, pixel data of each pixel is stored at a storage location corresponding to the position of each pixel inside the display area of the display device. Therefore, when generating data of an image displayed in the display device, the image processing controller stores the pixel data of each pixel of the image at a storage location of the display memory corresponding to the position of each pixel.

JP-A-10-49125 discloses a video display controller which functions as such an image processing controller, for example. In this video display controller, a VGA core generates data of an image displayed in the display device. A bit block transfer engine connected with the VGA core performs bit block transfer of the data of the display image between the VGA core and a DRAM controller which controls access to a DRAM.

When displaying an image input from the host or the like inside a predetermined rectangular area in the display area of the display device based on the data of the input image, the image processing controller must write the data of each pixel of the input image at a storage location of the display memory corresponding to the position of each pixel inside the rectangular area.

When displaying a background image painted in a background color inside a rectangular area in the display area, the image processing controller must write the data of each pixel of the background image at a storage location of the display memory corresponding to the position of each pixel inside the rectangular area. The pixel data of the background image is written by a function called a solid fill of the bit block transfer operation.

In a known image processing controller, a circuit which writes the pixel data of the input image into the display memory and a circuit which realizes the solid fill function are separately provided although these circuits similarly write the pixel data of the image inside the rectangular area. This results in an increase in the circuit scale of a memory controller which controls writing into the display memory, whereby the cost of the image processing controller is increased.

### SUMMARY

According to a first aspect of the invention, there is provided a memory controller which is used for writing pixel data into a memory, the memory controller comprising:

a rectangular area designation register in which data for designating a rectangular area inside a display area of a display device is set;

an address generation circuit which generates an address which specifies a storage location of the memory corresponding to a position of each pixel inside the rectangular area based on the data set in the rectangular area designation register;

a pixel data designation register in which pixel data subjected to bit block transfer is designated as designated pixel data; and

a bit block transfer control register which is used for enabling the bit block transfer;

when the bit block transfer is enabled by the bit block transfer control register, the memory controller writing the designated pixel data at a storage location of the memory corresponding to a position of each pixel inside the rectangular area, based on the address generated by the address generation circuit corresponding to a bit block transfer rectangular area; and

when the bit block transfer is disabled by the bit block transfer control register, the memory controller writing pixel data of a given input image at a storage location of the memory corresponding to a position of each pixel inside the rectangular area, based on the address generated by the address generation circuit corresponding to an input pixel data transfer rectangular area.

According to a second aspect of the invention, there is provided an image processing controller comprising:

a pixel data input interface to which input pixel data is input;

the above-described memory controller;

a memory which is write-controlled by the memory controller; and

a pixel data output interface which is used for outputting pixel data read from the memory.

According to a third aspect of the invention, there is provided an electronic instrument comprising:

a display device;

the above-described image processing controller; and

a display driver which drives the display device based on pixel data supplied from the image processing controller.

### BRIEF DESCRIPTION OF THE SEVERAL VIEWS OF THE DRAWING

FIG. 1 shows a configuration example of an electronic instrument to which a display controller as an image processing controller according to one embodiment of the invention is applied.

FIG. 2 is a block diagram of a configuration example of the display controller shown in FIG. 1.

FIG. 3 is a diagram illustrative of a memory controller and a display memory shown in FIG. 2.

FIG. 4 is a diagram illustrative of processing of an overlay processing section shown in FIG. 2.

FIG. 5 is a block diagram of a configuration example of the memory controller shown in FIG. 2.

FIG. 6 shows an outline of a configuration of a rectangular area designation register shown in FIG. 5.

FIG. 7 is illustrative of data set in the rectangular area designation register shown in FIG. 6.

FIG. 8 is a block diagram of a configuration example of an address generation circuit shown in FIG. 5.

FIG. 9 is illustrative of an offset address according to one embodiment of the invention.

FIG. 10 is illustrative of an operation of a bit block transfer pattern generation circuit shown in FIG. 5.

FIG. 11 is illustrative of a write operation of a bit block transfer pattern shown in FIG. 10.

### DETAILED DESCRIPTION OF THE EMBODIMENT

The invention may provide a memory controller which enables a reduction in cost due to a reduction in the circuit scale, an image processing controller, and an electronic instrument.

According to one embodiment of the invention, there is provided a memory controller which is used for writing pixel data into a memory, the memory controller comprising:

a rectangular area designation register in which data for designating a rectangular area inside a display area of a display device is set;

an address generation circuit which generates an address which specifies a storage location of the memory corresponding to a position of each pixel inside the rectangular area based on the data set in the rectangular area designation register;

a pixel data designation register in which pixel data subjected to bit block transfer is designated as designated pixel data; and

a bit block transfer control register which is used for enabling the bit block transfer;

when the bit block transfer is enabled by the bit block transfer control register, the memory controller writing the designated pixel data at a storage location of the memory corresponding to a position of each pixel inside the rectangular area, based on the address generated by the address generation circuit corresponding to a bit block transfer rectangular area; and

when the bit block transfer is disabled by the bit block transfer control register, the memory controller writing pixel data of a given input image at a storage location of the memory corresponding to a position of each pixel inside the rectangular area, based on the address generated by the address generation circuit corresponding to an input pixel data transfer rectangular area.

In this embodiment, either the input pixel data or the designated pixel data designated using the pixel data designation register is written at a storage location of the memory corresponding to the position of each pixel inside the rectangular area set in the display area of the display device. In this case, the designated pixel data can be written by the solid fill function.

In this embodiment, when writing the input pixel data and the bit block transfer designated pixel data, the address of the memory corresponding to each rectangular area separately set using the rectangular area designation register can be generated by the address generation circuit, and the pixel data can be written based on the generated address. Therefore, the address generation circuit and the rectangular area designation register can be used in common when writing the input pixel data and the bit block transfer designated pixel data, whereby the circuit scale of the memory controller can be reduced.

The memory controller may comprise:

a bit block transfer pattern generation circuit which generates a plurality of bit block transfer patterns based on the designated pixel data,

wherein, when the bit block transfer is enabled by the bit block transfer control register, the memory controller selects one of the bit block transfer patterns based on a position of each pixel inside the rectangular area or the address generated by the address generation circuit, and writes the designated pixel data at a storage location of the memory by using the selected bit block transfer pattern.

In this embodiment, the bit block transfer pattern is generated by using the designated pixel data designated using the pixel data designation register. When performing the bit block transfer, the bit block transfer pattern is written into the memory without writing the designated pixel data designated using the pixel data designation register into the memory each time the bit block transfer is performed. Therefore, the number of times that the memory controller accesses the memory can be reduced. As a result, an increase in the bit block transfer speed and a reduction in the amount of power consumed by the transfer can be achieved.

The memory controller may comprise:

a format designation register which is used for designating a format of pixel data,

wherein the bit block transfer pattern generation circuit generates the bit block transfer patterns, each having a number of bits of a width of a bus through which data is written into the memory, by using the designated pixel data having a number of bits per pixel corresponding to the format.

In this memory controller,

when a number of bits of the designated pixel data is denoted by s (s is an integer greater than one), a number of bits of a width of a bus through which data is written into the memory is denoted by m (m>s, m is an integer), and a least common multiple of s and m is denoted by M (M is an integer), the bit block transfer pattern generation circuit may include a buffer which stores M-bit data, and generate M/m m-bit bit block transfer patterns by dividing the data stored in the buffer, into which M/s pieces of the designated pixel data have been written, in m-bit units in a bit arrangement order.

In this embodiment, one of the bit block transfer patterns can be selected and written into the memory, whereby an increase in the bit block transfer speed and a reduction in the amount of power consumed by the transfer can be achieved.

For example, when the width of the bus through which the data is written into the memory cannot be divided (remainder is not zero) by the number of bits of the designated pixel data, the number of unnecessary accesses to the memory is increased. According to this embodiment, the designated pixel data can be written into the memory in units of the width of the bus through which the data is written into the memory without taking into consideration the end of the bit of the data written into the memory per address or the end of the bit of the designated pixel data. This makes additional control such as bit alignment control unnecessary and eliminates unnecessary access to the memory.

In this memory controller,

the rectangular area designation register may include:

a horizontal direction start position setting register in which a start position of the rectangular area in a horizontal direction of the display area is set;

a vertical direction start position setting register in which a start position of the rectangular area in a vertical direction of the display area is set;

a horizontal direction end position setting register in which an end position of the rectangular area in the horizontal direction of the display area is set;

a vertical direction end position setting register in which an end position of the rectangular area in the vertical direction of the display area is set;

a horizontal direction size setting register in which a size of the display area in the horizontal direction is set; and

a vertical direction size setting register in which a size of the display area in the vertical direction is set; and

the address generation circuit may generate an address of the memory corresponding to a position of each pixel inside the rectangular area, based on data set in the horizontal direction start position setting register, the vertical direction start position setting register, the horizontal direction end position setting register, the vertical direction end position setting register, the horizontal direction size setting register, and the vertical direction size setting register.

This makes it possible to generate an address by a simple configuration corresponding to the designated rectangular area.

In this memory controller,

a storage area of the memory may include a bit block transfer data storage area and an input pixel data storage area; and

the memory controller may write the designated pixel data at a storage location inside the bit block transfer data storage area corresponding to a position of each pixel inside the rectangular area, and write pixel data of the input image at a storage location inside the input pixel data storage area corresponding to a position of each pixel inside the rectangular area.

Since the bit block transfer data storage area and the input pixel data storage area are provided in the storage area of the memory, it is unnecessary to store the data of the overlaid image in the memory, whereby a configuration can be employed in which the overlay processing is performed only when necessary. As a result, the circuit scale of the memory controller can be further reduced.

The memory controller may comprise a status register which is used for monitoring data set in the bit block transfer control register.

Whether the bit block transfer is enabled or disabled can be determined by referring to the status register. Therefore, when the bit block transfer is enabled, supplying of the pixel data can be controlled such as suspending supplying of the input pixel data, whereby the capacity of the buffer which prevents overflow of the input pixel data or the like can be reduced.

According to one embodiment of the invention, there is provided an image processing controller comprising:

a pixel data input interface to which input pixel data is input;

the above-described memory controller;

a memory which is write-controlled by the memory controller; and

a pixel data output interface which is used for outputting pixel data read from the memory.

According to this embodiment, an image processing controller including a memory controller which enables a reduction in cost due to a reduction in the circuit scale can be provided.

According to one embodiment of the invention, there is provided an electronic instrument comprising:

a display device;

the above-described image processing controller; and

a display driver which drives the display device based on pixel data supplied from the image processing controller.

According to this embodiment, an electronic instrument to which a memory controller which enables a reduction in cost due to a reduction in the circuit scale is applied can be provided.

These embodiments of the invention will be described in detail below, with reference to the drawings. Note that the embodiments described below do not in any way limit the scope of the invention laid out in the claims herein. In addition, not all of the elements of the embodiments described below should be taken as essential requirements of the invention.

1. Electronic Instrument

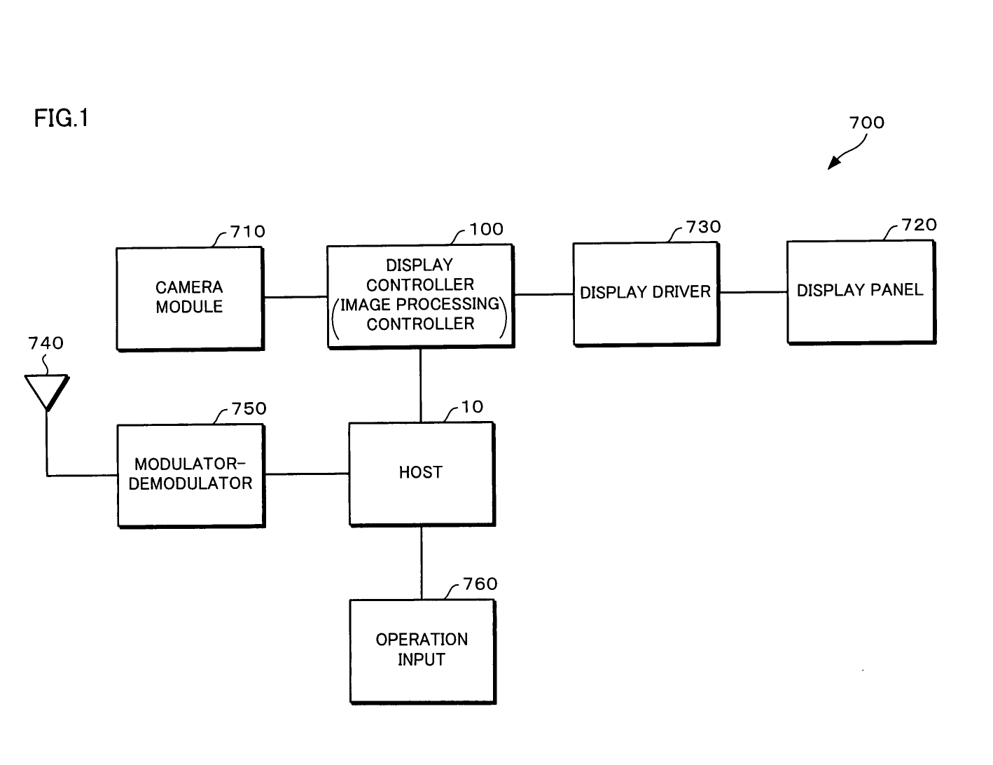

FIG. 1 shows a configuration example of an electronic instrument to which a display controller as an image processing controller according to one embodiment of the invention is applied. FIG. 1 is a block diagram of a configuration example of a portable telephone as the electronic instrument. Note that the electronic instrument to which the display controller as the image processing controller according to the embodiment of the invention is applied is not limited to the portable telephone.

A portable telephone 700 includes a camera module 710. The camera module 710 includes a charge coupled device (CCD) sensor or a complementary metal-oxide-semiconductor (CMOS) sensor, and supplies pixel data of an image captured by the CCD sensor or the CMOS sensor to a display controller (image processing controller in a broad sense) 100.

The portable telephone 700 includes a display panel (electro-optical device in a broad sense; display device in a broader sense) 720. An LCD panel may be used as the display panel 720. In this case, the display panel 720 is driven by a display driver 730. The display panel 720 includes scan lines, data lines, and pixels. The display driver 730 has a function of a scan driver which selects the scan lines in units of one or more scan lines, and a function of a data driver which supplies voltage corresponding to pixel data of an image to the data lines.

The display controller 100 is connected with the display driver 730, and supplies pixel data in the RGB format to the display driver 730.

A host 10 is connected with the display controller 100. The host 10 controls the display controller 100. The host 10 demodulates data received through an antenna 740 and including pixel data of an image using a modulator-demodulator section 750, and supplies the demodulated data to the display controller 100. The display controller 100 causes the display driver 730 to display an image on the display panel 720 based on the pixel data.

The host 10 modulates pixel data of an image generated by the camera module 710 using the modulator-demodulator section 750, and directs transmission of the modulated data to another communication device through the antenna 740.

The host 10 transmits and receives communication data including pixel data of an image, images using the camera module 710, and displays an image on the display panel based on operation information from an operation input section 760.

In FIG. 1, the LCD panel is used as an example of the display panel 720. However, the display panel 720 is not limited to the LCD panel. The display panel 720 may be an electroluminescent display device or a plasma display device. The invention may be applied to a display controller which supplies pixel data to a display driver which drives such a display panel.

2. Display Controller

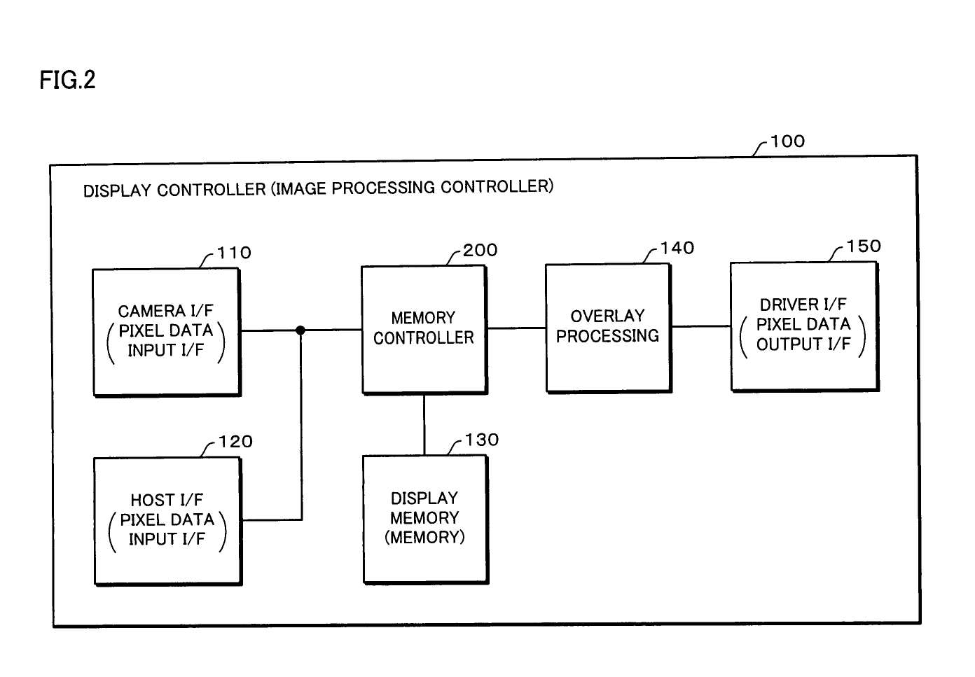

FIG. 2 is a block diagram of a configuration example of the display controller 100 shown in FIG. 1.

The display controller 100 according to the embodiment of the invention need not include all of the blocks shown in FIG. 2, and may have a configuration in which at least one of the blocks shown in FIG. 2 is omitted.

The display controller (image processing controller) 100 includes a camera interface (hereinafter abbreviated as “I/F”) 110 as a pixel data input I/F, a host I/F 120, a memory controller 200, a display memory (memory in a broad sense) 130, an overlay processing section 140, and a driver I/F 150 as a pixel data output I/F. Therefore, the display controller 100 includes the pixel data input I/F, the memory controller, the memory, and the pixel data output I/F.

The pixel data from the camera module 710 is input to the camera I/F 110. Specifically, the pixel data inside the effective pixel area of the imaging device of the camera module 710 is input to the camera I/F 110. In more detail, the camera I/F 110 performs interface processing of the pixel data (reception from the camera module or signal buffering), and outputs the pixel data after the interface processing to the memory controller 200.

The pixel data of an image generated by the host 10 and control data for controlling the display controller 100 from the host 10 are input to the host I/F 120. The host I/F 120 performs interface processing (reception from the host or signal buffering), and supplies the pixel data after the interface processing to the memory controller 200. The pixel data read from the display memory 130 by the memory controller 200, the control data set in the memory controller 200 or the like, and data set in a status register are input to the host I/F 120. The host I/F 120 performs interface processing (transmission to the host or signal buffering), and outputs the pixel data after the interface processing to the host 10.

The memory controller 200 writes the pixel data into the display memory 130. When writing the pixel data into the display memory 130, the memory controller 200 writes the pixel data of each pixel at a storage location of the display memory 130 corresponding to the position of each pixel inside the display area of the display panel 720. The memory controller 200 also reads the pixel data from the display memory 130.

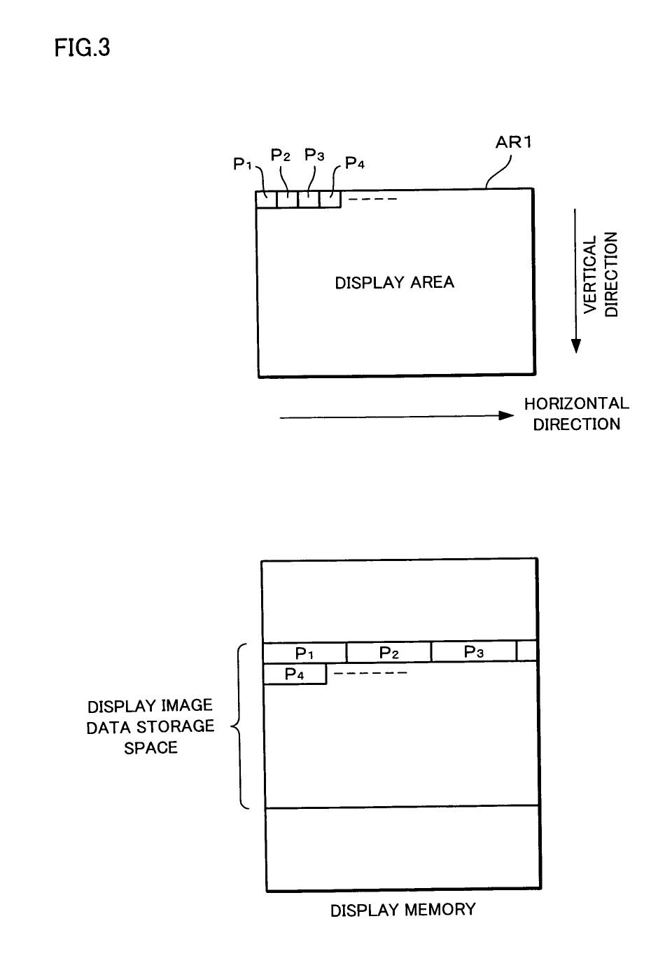

FIG. 3 is a diagram illustrative of the memory controller 200 and the display memory 130 shown in FIG. 2.

Pixels P₁, P₂, P₃, . . . are arranged in a display area AR1 of the display panel 720 in the horizontal direction, and the pixel data is stored in the display memory 130 in the order of the pixels P₁, P₂, P₃, . . . of the image displayed in the display area AR1.

A memory space in which the pixel data of the image displayed in the display area AR1 is stored has been determined in the display memory 130. The pixel data of the pixels P₁, P₂, P₃, . . . is stored in the memory space in that order. The pixel data of one screen (frame) is read from the display memory 130 in a predetermined refresh cycle and a predetermined order.

In FIG. 2, the memory controller 200 writes the pixel data of the image input from the camera I/F 110 or the host I/F 120 at a storage location of the display memory 130 corresponding to the position of each pixel inside the rectangular area of the display area. The memory controller 200 has a solid fill function, and fills a storage area of the display memory 130 corresponding to the position of each pixel inside the rectangular area of the display area with designated pixel data of one or more pixels such as pixel data of a background image, for example.

As described above, the pixel data of two or more images can be stored in the display memory 130. The overlay processing section 140 causes the pixel data of two or more images stored in the display memory 130 to overlay. For example, the overlay processing section 140 generates pixel data of an image in which the background image overlays the image input from the camera I/F 110 or the host I/F 120, and outputs the pixel data to the driver I/F 150.

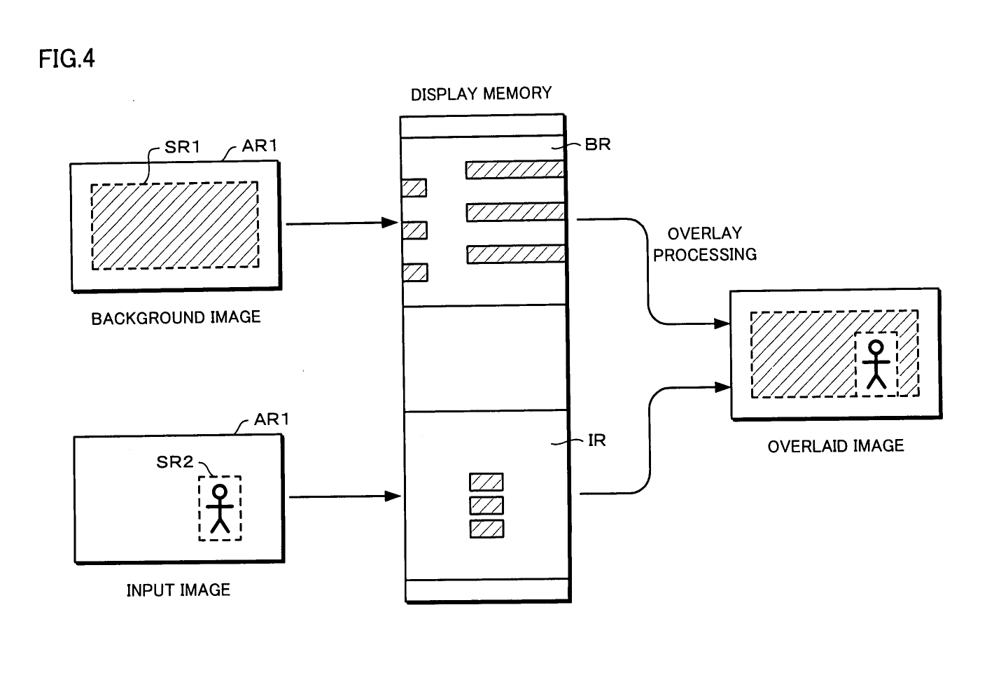

FIG. 4 is a diagram illustrative of the processing of the overlay processing section 140 shown in FIG. 2.

The storage area of the display memory 130 includes a bit block transfer data storage area BR and an input pixel data storage area IR.

The pixel data of the background image in which a rectangular area SR1 inside the display area AR1 is filled with the designated pixel data of one or more pixels is written into the bit block transfer data storage area BR. The memory controller 200 writes the pixel data of the background image into the bit block transfer data storage area BR of the display memory 130 by the solid fill function.

The pixel data of the image input from the camera module or the host and displayed inside a rectangular area SR2 inside the display area AR1 is written into the input pixel data storage area IR. The memory controller 200 writes the pixel data of the input image into the input pixel data storage area IR of the display memory 130 before or after writing the pixel data of the background image.

The overlay processing section 140 reads the pixel data stored in the bit block transfer data storage area BR of the display memory 130 and the pixel data stored in the input pixel data storage area IR of the display memory 130, and performs overlay processing.

It becomes unnecessary to store the data of the overlaid image in the display memory 130 by providing the bit block transfer data storage area BR and the input pixel data storage area IR and overlaying the images after reading the pixel data from the display memory 130. The overlay processing is performed only when necessary, and the data of the processed image is output.

In FIG. 2, the driver I/F 150 outputs the pixel data output from the overlay processing section 140 to the display driver 730. The driver I/F 150 performs interface processing of the pixel data (transmission to the display driver or signal buffering), and outputs the pixel data after the interface processing to the display driver 730.

3. Memory Controller

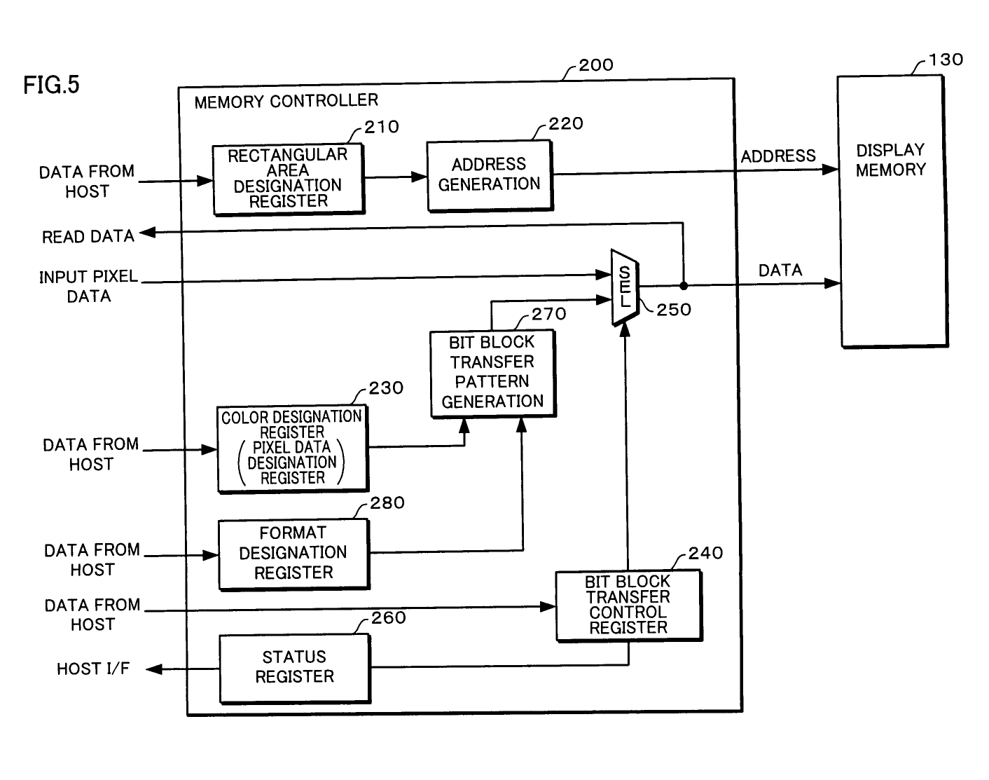

FIG. 5 is a block diagram of a configuration example of the memory controller 200 shown in FIG. 2.

The memory controller 200 includes a rectangular area designation register 210, an address generation circuit 220, a color designation register (pixel data designation register) 230, and a bit block transfer control register 240.

Data for designating the rectangular area inside the display area of the LCD panel (display device in a broad sense) is set in the rectangular area designation register 210. The data is set by the host 10 through the host I/F 120.

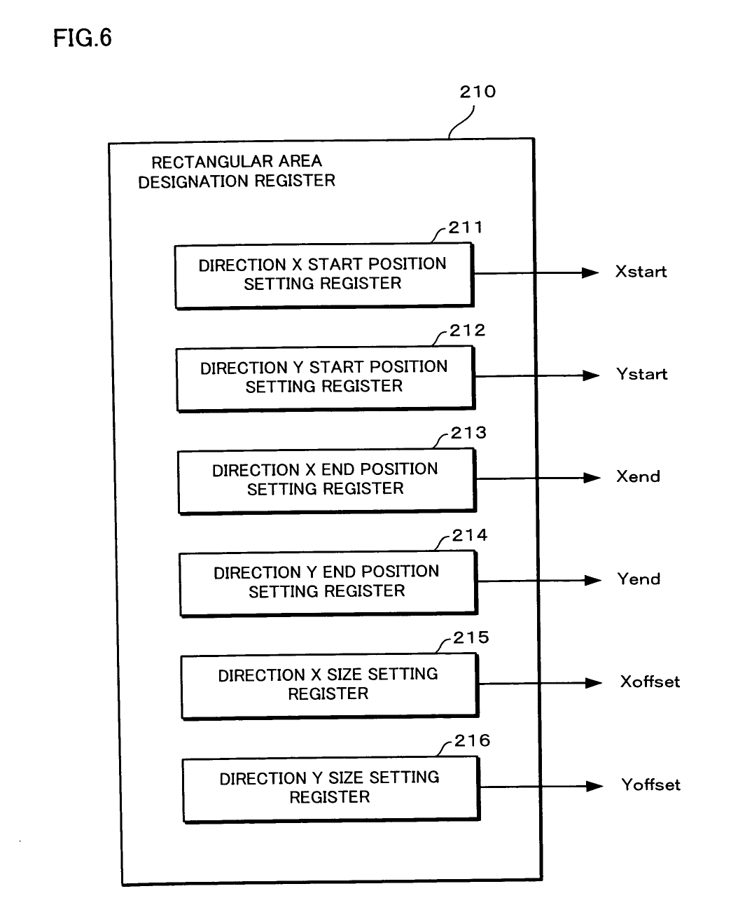

FIG. 6 shows an outline of a configuration of the rectangular area designation register 210 shown in FIG. 5.

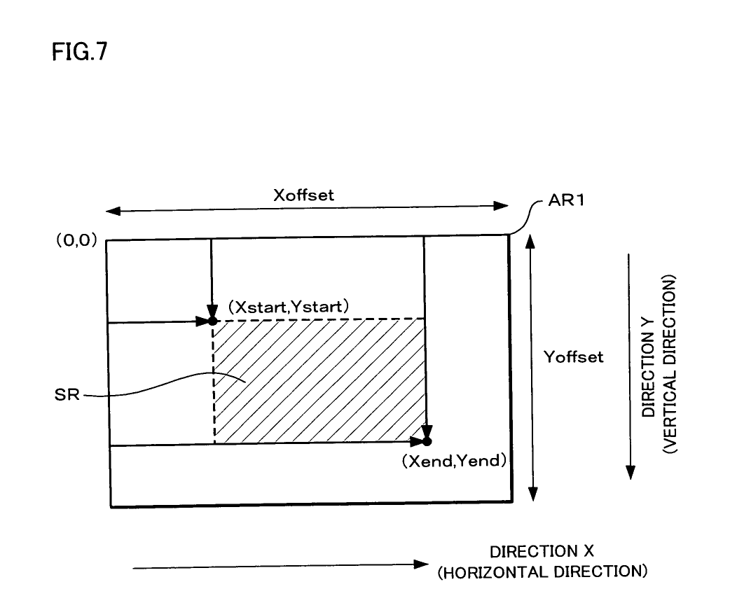

FIG. 7 is a diagram illustrative of the data set in the rectangular area designation register 210 shown in FIG. 6.

As shown in FIG. 6, the rectangular area designation register 210 includes a direction X start position setting register (horizontal direction start position setting register) 211, a direction Y start position setting register (vertical direction start position setting register) 212, a direction X end position setting register (horizontal direction end position setting register) 213, a direction Y end position setting register (vertical direction end position setting register) 214, a direction X size setting register (horizontal direction size setting register) 215, and a direction Y size setting register (vertical direction size setting register) 216.

FIG. 7 shows the rectangular area SR designated inside the display area AR1. The horizontal direction of the image in the display area is designated as a direction X, the vertical direction of the image is designated as a direction Y, and the position of the pixel at the upper left corner of the display area is set as the origin (0,0). The rectangular area SR is defined by the position (Xstart,Ystart) of the pixel at the upper left of the rectangular area SR and the position (Xend,Yend) of the pixel at the lower right of the rectangular area SR. A direction X start position Xstart is set in the direction X start position setting register 211. A direction Y start position Ystart is set in the direction Y start position setting register 212. A direction X end position Xend is set in the direction X end position setting register 213. A direction Y end position Yend is set in the direction Y end position setting register 214.

A direction X size Xsize is set in the direction X size setting register 215, and a direction Y size Ysize is set in the direction Y size setting register 216. The direction X size Xsize and the direction Y size Ysize are used to calculate an address offset value which specifies the storage location of the display memory 130 in which the pixel data inside the rectangular area is stored.

The host 10 sets the data in each register of the rectangular area designation register 210 shown in FIG. 7 through the host I/F 120.

Again referring to FIG. 5, the address generation circuit 220 generates a write address which specifies a storage location of the display memory 130 corresponding to the position of each pixel inside the rectangular area based on the data set in the rectangular area designation register 210. The address generation circuit 220 also generates a read address of the display memory 130.

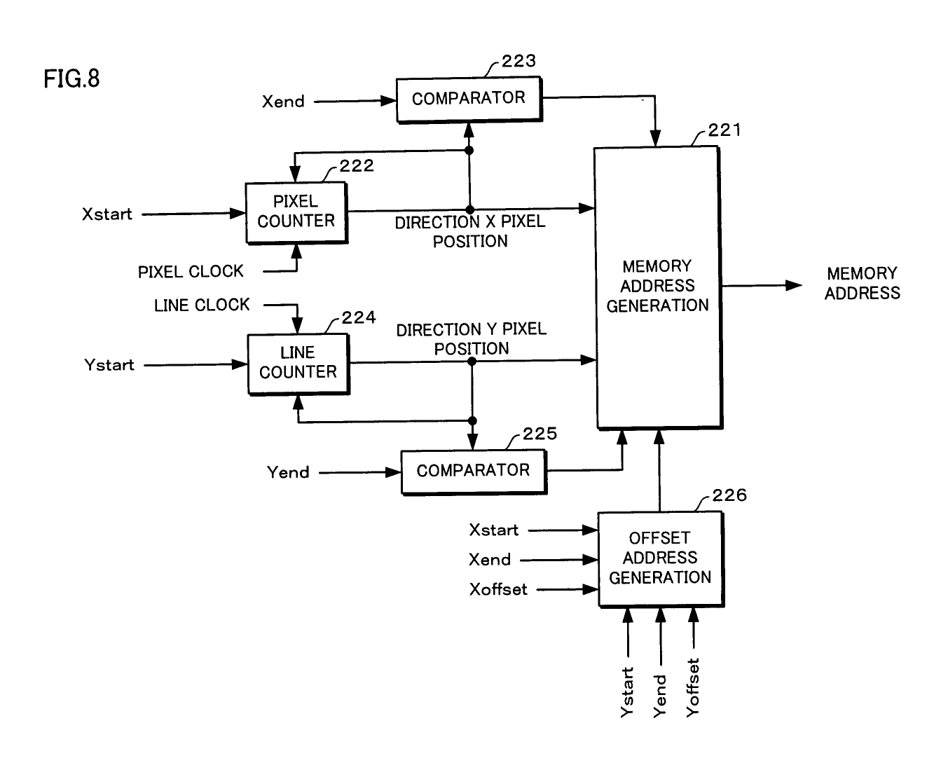

FIG. 8 is a block diagram of a configuration example of the address generation circuit 220 shown in FIG. 5.

The address generation circuit 220 generates the (write) address of the display memory 130 corresponding to the position (pixel position) inside the display area. The address generation circuit 220 includes a memory address generation circuit 221. The memory address generation circuit 221 generates the address of the display memory 130 based on the size of the display area and the positions of the rectangular area and the pixel. The pixel position is specified by a direction X pixel position and a direction Y pixel position.

The direction X pixel position is generated by a pixel counter 222 which counts up the pixel position in synchronization with a pixel clock signal. The pixel clock signal is a clock signal which changes in synchronization with the pixel data of each pixel. The pixel counter 222 counts up the direction X start position Xstart in synchronization with the pixel clock signal in the initial state, and then counts up the output from the pixel counter 222. When a comparator 223 has detected that the pixel position has reached the direction X end position Xend, the comparator 223 notifies the memory address generation circuit 221 to that effect.

The direction Y pixel position is generated by a line counter 224 which counts up the pixel position in synchronization with a line clock signal. The line clock signal is a clock signal which specifies one horizontal line of the image. The line counter 224 counts up the direction Y start position Ystart in synchronization with the line clock signal in the initial state, and then counts up the output from the line counter 224. When a comparator 225 has detected that the pixel position has reached the direction Y end position Yend, the comparator 225 notifies the memory address generation circuit 221 to that effect.

The address generation circuit 220 includes an offset address generation circuit 226. The offset address generation circuit 226 generates an offset address as an offset value for generating the address of the display memory 130 corresponding to the pixel position of the rectangular area set in the display area.

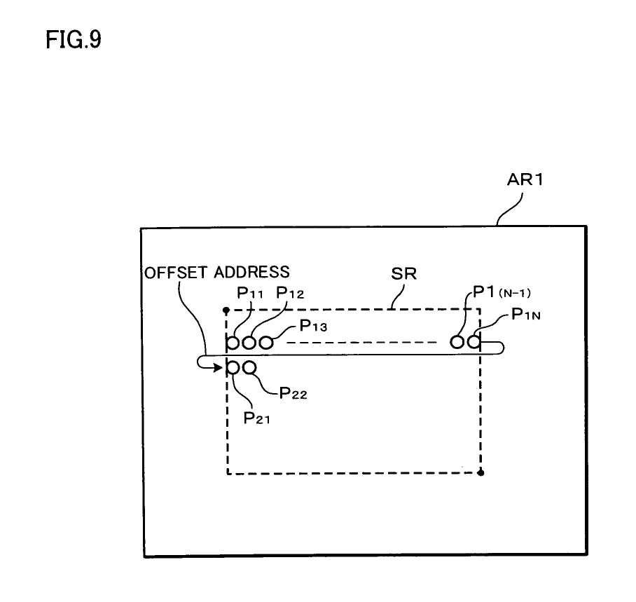

FIG. 9 shows a diagram illustrative of the offset address according to the embodiment of the invention.

For example, the rectangular area SR is set in the display area AR1 as shown in FIG. 9. After calculating the addresses of the display memory 130 respectively corresponding to pixel positions P₁₁, P₁₂, . . . , P_{1(N-1)}, P_{1N} of one line inside the rectangular area SR, a pixel position P₂₁ of the next line is calculated. The write addresses of the pixel positions PIN and P₂₁ in the display memory 130 are not in succession.

Therefore, in order to calculate the address corresponding to the pixel position P₂₁ from the address corresponding to the pixel position PIN, a value corresponding to the size of the display area AR1 and the position of the rectangular area SR is added to the address corresponding to the pixel position P_{1N}. This value corresponds to the offset address.

The offset address generation circuit 226 generates the offset address based on the direction X start position Xstart, the direction X end position Xend, the direction X size Xsize, the direction Y start position Ystart, the direction Y end position Yend, and the direction Y size Ysize. The offset address is supplied to the memory address generation circuit 221.

The memory address generation circuit 221 generates the address of the display memory 130 using the offset address on condition that the memory address generation circuit 221 has been notified by the comparators 223 and 225 that the pixel position has reached the end position of the rectangular area SR.

As described above, the address generation circuit 220 generates the address of the display memory 130 based on the data set in the direction X start position setting register 211, the direction Y start position setting register 212, the direction X end position setting register 213, the direction Y end position setting register 214, the direction X size setting register 215, and the direction Y size setting register 216.

In the embodiment of the invention, the configuration of the address generation circuit 220 is not limited to the configuration shown in FIG. 8. FIG. 8 illustrates the configuration of generating the write address of the display memory 130. The read address of the display memory 130 may also be generated in the same manner as the write address.

Description returns to FIG. 5.

In FIG. 5, the pixel data of one or more pixels subjected to bit block transfer is designated in the color designation register (pixel data designation register) 230 as the designated pixel data. The designated pixel data is set by the host 10 through the host I/F 120.

The bit block transfer control register 240 is a register for enabling bit block transfer. The host 10 accesses the bit block transfer control register 240 through the host I/F 120.

The memory controller 200 may include a status register 260. The status register 260 is a register for monitoring the data (content) set in the bit block transfer control register 240. The host 10 determines whether the bit block transfer is enabled or disabled using the bit block transfer control register 240 by referring to the status register 260 through the host I/F 120. Therefore, when the bit block transfer is enabled using the bit block transfer control register 240, the host 10 controls supplying of the pixel data such as suspending supplying of the input pixel data, whereby the capacity of a buffer which prevents overflow of the input pixel data or the like can be reduced.

When the bit block transfer is enabled using the bit block transfer control register 240, the memory controller 200 writes the designated pixel data at each storage location of the display memory 130 corresponding to the position of each pixel inside the rectangular area based on the address generated by the address generation circuit 220 corresponding to a bit block transfer rectangular area.

When the bit block transfer is disabled using the bit block transfer control register 240, the memory controller 200 writes the pixel data of the image (given input image) input through the camera I/F 110 or the host I/F 120 into the storage location of the display memory 130 corresponding to the position of each pixel inside the rectangular area based on the address generated by the address generation circuit 220 corresponding to an input pixel data rectangular area.

The memory controller 200 may include a selector 250 which selects either the input pixel data (pixel data of the input image) or the bit block transfer pixel data as the data written into the display memory 130 based on the data (setting value, access result, control data, or control result) set in the bit block transfer control register 240.

As described above, the rectangular area for writing the input pixel data and the rectangular area for writing the bit block transfer pixel data are respectively designated using the rectangular area designation register 210, and the write address of the display memory 130 is generated using the address generation circuit 220. Therefore, the address generation circuit 220 and the rectangular area designation register 210 can be used in common when writing the input pixel data and the bit block transfer pixel data, whereby the circuit scale of the memory controller 200 can be reduced.

In the memory controller 200 shown in FIG. 5, it is preferable that the bit block transfer be performed by generating a bit block transfer pattern using the pixel data and writing the bit block transfer pattern into the display memory 130 without writing the pixel data of one or more pixels designated using the color designation register 230 into the display memory 130 each time the bit block transfer is performed. Therefore, it is preferable that the memory controller 200 include a bit block transfer pattern generation circuit 270. This reduces the number of times that the memory controller 200 accesses the display memory 130. As a result, an increase in the bit block transfer speed and a reduction in the amount of power consumed by the transfer can be achieved.

In more detail, it is preferable that the bit block transfer pattern generation circuit 270 generate a plurality of bit block transfer patterns based on the pixel data designated using the color designation register 230. The memory controller 200 selects one of the bit block transfer patterns based on the address generated by the address generation circuit 220, and writes the data into the display memory 130 using the selected bit block transfer pattern.

The width of the bus through which the data is written into the display memory 130 may differ from the number of bits of pixel data of one or more pixels designated using the color designation register 230. In this case, one of the bit block transfer patterns generated in advance can be selected and written into the display memory 130, whereby an increase in the bit block transfer speed and a reduction in the amount of power consumed by the transfer can be achieved.

It is preferable that the memory controller 200 include a format designation register 280 for designating the format of the pixel data. Examples of the format of the pixel data include an RGB format in which the pixel data of one pixel is expressed by color component data and a YUV format in which one or more pieces of pixel data are expressed by luminance component data and color difference component data. The RGB format is classified into various formats depending on the color component data expression method. These formats differ in the number of bits of pixel data of one pixel. The YUV format is also classified into various formats depending on the color difference component data expression method. These formats differ in the number of bits of pixel data of one pixel.

Therefore, when the width of the bus through which the data is written into the display memory 130 cannot be divided (remainder is not zero) by the number of bits of one or more pieces of pixel data, the number of unnecessary accesses to the display memory 130 is increased. In this case, the bit block transfer pattern generation circuit generates a plurality of bit block transfer patterns, each having a number of bits corresponding to the width of the bus through which the data is written into the display memory 130, using the designated pixel data having a number of bits per pixel corresponding to the format designated using the color designation register 230.

This enables the pixel data to be written into the display memory 130 in units of the width of the bus through which the data is written into the display memory 130, whereby the number of unnecessary accesses to the display memory 130 can be reduced.

Specifically, the number of bits of the designated pixel data designated using the color designation register 230 is denoted by s (s is an integer greater than one), the number of bits of the width of the bus through which the data is written into the display memory 130 is denoted by m (m>s, m is an integer), and the least common multiple of s and m is denoted by M (M is an integer). In this case, the bit block transfer pattern generation circuit 270 may include a buffer which can store M-bit data. M/s pieces of designated pixel data are stored in the buffer, and the data stored in the buffer is divided in m-bit units in the bit arrangement order. As a result, M/m types of m-bit bit block transfer patterns can be generated.

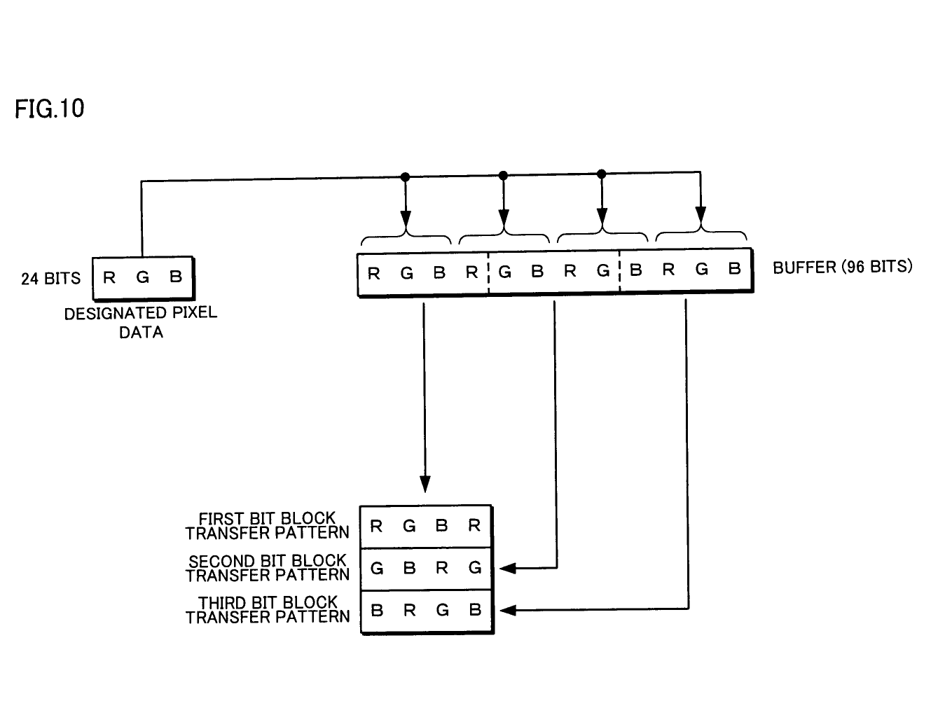

FIG. 10 is a diagram illustrative of the operation of the bit block transfer pattern generation circuit 270 shown in FIG. 5.

In FIG. 10, an RGB888 format has been designated using the format designation register 280. In the RGB888 format, each piece of color component data of pixel data of one pixel is expressed by eight bits. Therefore, the number of bits “s” of designated pixel data “RGB” is 24.

In FIG. 10, the number of bits “m” of the width of the bus through which the data is written into the display memory 130 is 32. Therefore, the number of bits “M” of data which can be stored in the buffer is 96.

The 24-bit designated pixel data is successively and sequentially written into the adjacent bits of the buffer. As a result, four (=96/24=M/s) pieces of designated pixel data are stored in the buffer. Specifically, the data “RGBRGBRGBRGB” is stored in the buffer.

The data stored in the buffer is divided in units of 32 (=m) bits in the bit arrangement order. As a result, first to third bit block transfer patterns (three (=96/32=M/m) types of 32 (=m) bit bit block transfer patterns) can be generated. Specifically, the first bit block transfer pattern is “RGBR”, the second bit block transfer pattern is “GBRG”, and the third bit block transfer pattern is “BRGB”.

FIG. 1 is a diagram illustrative of the write operation of the bit block transfer pattern shown in FIG. 10.

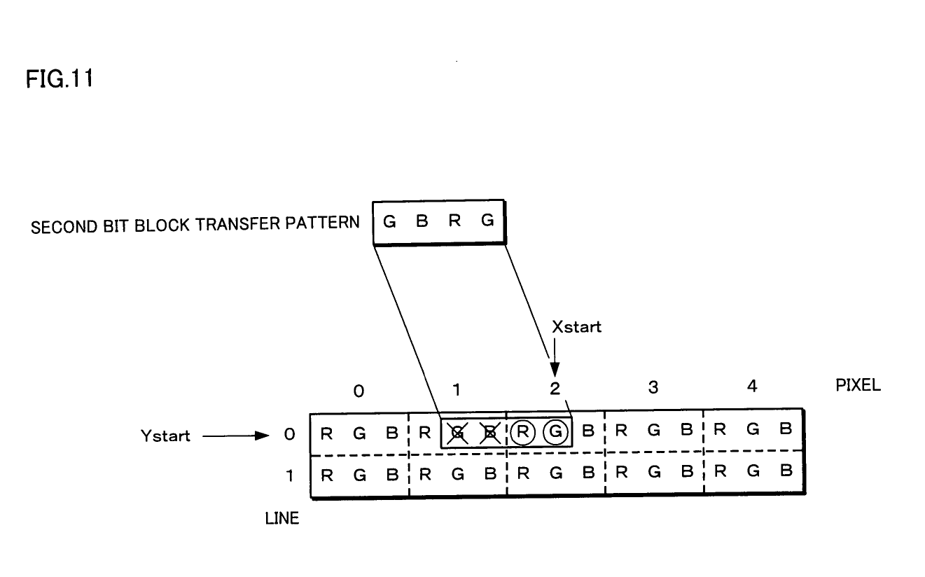

In FIG. 11, the direction X size Xsize of the display area is five, and the direction Y size Ysize is two. A rectangular area of which the direction X start position Xstart is two and the direction Y start position Ystart is zero is set in the display area.

The data is written into the display memory 130 in 32-bit units, and the pixel data of each pixel is 24 bits. Consider the case of writing the bit block transfer pattern at a storage location of the display memory 130 corresponding to the pixel position (Xstart,Ystart) inside the rectangular area.

In the embodiment of the invention, the second bit block transfer pattern is selected from the first to third bit block transfer patterns shown in FIG. 10 based on the pixel position (Xstart,Ystart) or the address corresponding to the pixel position. The second bit block transfer pattern is written at a storage location of the display memory 130 corresponding to the pixel position (Xstart,Ystart). Since the pixel position (1,0) is outside the rectangular area, the operation is controlled so that the data G and B at the pixel position (1,0) is not overwritten by the second bit block transfer pattern. One of the first to third bit block transfer patterns is selected for the remaining pixel position inside the rectangular area based on the pixel position or the address corresponding to the pixel position and written at a storage location of the display memory 130 corresponding to each pixel position.

Since the bit block transfer patterns are generated by the bit block transfer pattern generation circuit 270 and the bit block transfer pattern is written based on the pixel position or the address of the display memory 130 corresponding to the pixel position, the data can be bit block transferred to the display memory 130 at high speed without an unnecessary access.

FIGS. 10 and 11 illustrate the case of designating the RGB format using the format designation register 280. The same description also applies to the case of designating the YUV format.

The invention is not limited to the above-described embodiments. Various modifications and variations may be made within the spirit and scope of the invention. For example, the invention may be applied not only to drive the above-described liquid crystal display panel, but also to drive an electroluminescent or plasma display device.

Part of requirements of any claim of the invention could be omitted from a dependent claim which depends on that claim. Moreover, part of requirements of any independent claim of the invention could be made to depend on any other independent claim.

Although only some embodiments of the invention have been described in detail above, those skilled in the art will readily appreciate that many modifications are possible in the embodiments without departing from the novel teachings and advantages of this invention. Accordingly, all such modifications are intended to be included within the scope of this invention.

What is claimed is:

1. A memory controller which is used for writing pixel data into a memory, the memory controller comprising:
a rectangular area designation register in which data for designating a rectangular area inside a display area of a display device is set;
an address generation circuit which generates an address which specifies a storage location of the memory corresponding to a position of each pixel inside the rectangular area based on the data set in the rectangular area designation register;
a pixel data designation register in which pixel data subjected to bit block transfer is designated as designated pixel data; and
a bit block transfer control register which is used for enabling the bit block transfer;
when the bit block transfer is enabled by the bit block transfer control register, the memory controller writing the designated pixel data at a storage location of the memory corresponding to a position of each pixel inside the rectangular area, based on the address generated by the address generation circuit corresponding to a bit block transfer rectangular area; and
when the bit block transfer is disabled by the bit block transfer control register, the memory controller writing pixel data of a given input image at a storage location of the memory corresponding to a position of each pixel inside the rectangular area, based on the address generated by the address generation circuit corresponding to an input pixel data transfer rectangular area.

2. The memory controller as defined in claim 1, comprising:
a bit block transfer pattern generation circuit which generates a plurality of bit block transfer patterns based on the designated pixel data,
wherein, when the bit block transfer is enabled by the bit block transfer control register, the memory controller selects one of the bit block transfer patterns based on a position of each pixel inside the rectangular area or the address generated by the address generation circuit, and writes the designated pixel data at a storage location of the memory by using the selected bit block transfer pattern.

3. The memory controller as defined in claim 2, comprising:
a format designation register which is used for designating a format of pixel data,
wherein the bit block transfer pattern generation circuit generates the bit block transfer patterns, each having a number of bits of a width of a bus through which data is written into the memory, by using the designated pixel data having a number of bits per pixel corresponding to the format.

4. The memory controller as defined in claim 2,
wherein, when a number of bits of the designated pixel data is denoted by s (s is an integer greater than one), a number of bits of a width of a bus through which data is written into the memory is denoted by m (m>s, m is an integer), and a least common multiple of s and m is denoted by M (M is an integer), the bit block transfer pattern generation circuit includes a buffer which stores M-bit data, and generates M/m m-bit bit block transfer patterns by dividing the data stored in the buffer, into which M/s pieces of the designated pixel data have been written, in m-bit units in a bit arrangement order.

5. The memory controller as defined in claim 1,
wherein the rectangular area designation register includes:
a horizontal direction start position setting register in which a start position of the rectangular area in a horizontal direction of the display area is set;
a vertical direction start position setting register in which a start position of the rectangular area in a vertical direction of the display area is set;
a horizontal direction end position setting register in which an end position of the rectangular area in the horizontal direction of the display area is set;
a vertical direction end position setting register in which an end position of the rectangular area in the vertical direction of the display area is set;
a horizontal direction size setting register in which a size of the display area in the horizontal direction is set; and
a vertical direction size setting register in which a size of the display area in the vertical direction is set; and
wherein the address generation circuit generates an address of the memory corresponding to a position of each pixel inside the rectangular area, based on data set in the horizontal direction start position setting register, the vertical direction start position setting register, the horizontal direction end position setting register, the vertical direction end position setting register, the horizontal direction size setting register, and the vertical direction size setting register.

6. The memory controller as defined in claim 1,
wherein a storage area of the memory includes a bit block transfer data storage area and an input pixel data storage area; and
wherein the memory controller writes the designated pixel data at a storage location inside the bit block transfer data storage area corresponding to a position of each pixel inside the rectangular area, and writes pixel data of the input image at a storage location inside the input pixel data storage area corresponding to a position of each pixel inside the rectangular area.

7. The memory controller as defined in claim 1, comprising a status register which is used for monitoring data set in the bit block transfer control register.

8. An image processing controller comprising:
a pixel data input interface to which input pixel data is input;
the memory controller as defined in claim 1;
a memory which is write-controlled by the memory controller; and
a pixel data output interface which is used for outputting pixel data read from the memory.

9. An electronic instrument comprising:
a display device;
the image processing controller as defined in claim 8; and
a display driver which drives the display device based on pixel data supplied from the image processing controller.
